(19) United States
(12) Patent Application Publication
(10) Pub. No.: US 2006/0056180 A1
(43) Pub. Date: Mar. 16, 2006

(54) Light source for control illumination

(76) Inventors: Mark G. Feldman, Farmington Hills, MI (US); Robert Mark Schmidt, Livonia, MI (US)

Correspondence Address: WILDMAN HARROLD ALLEN & DIXON LLP, 225 WEST WACKER DRIVE, SUITE 2800, CHICAGO, IL, 60606, US

(21) Appl. No.: 10/942,601

(22) Filed: Sep. 16, 2004

(51) Int. Cl. F21V 33/00

(52) U.S. Cl. 362/253

(57) ABSTRACT

A control illumination apparatus having an interior trim panel that has at least one control. At least one direct light source is connected to the interior trim panel and projects a predetermined light pattern onto the exterior surface of the control.

### FIELD OF THE INVENTION

This invention relates generally to light sources for control illumination. In particular, this invention relates to light sources for illuminating controls in the interior trim of automobiles.

### SUMMARY OF THE INVENTION

In one embodiment, the present invention relates to a control illumination apparatus having an interior trim panel that has at least one control. At least one direct light source is connected to the interior trim panel and projects a predetermined light pattern onto the exterior surface of the control.

The present invention also relates to a method for illuminating a set of controls on an interior trim panel wherein at least one direct light source is connected to the interior trim panel and a predetermined light pattern is projected from the at least one direct light source onto the exterior surface of the set of controls.

### BRIEF DESCRIPTION OF THE DRAWINGS

FIG. 1 is a perspective view of an automobile door panel using the control illumination of the present invention.

FIG. 2 is a side view of the automobile door panel of FIG. 1.

### DETAILED DESCRIPTION

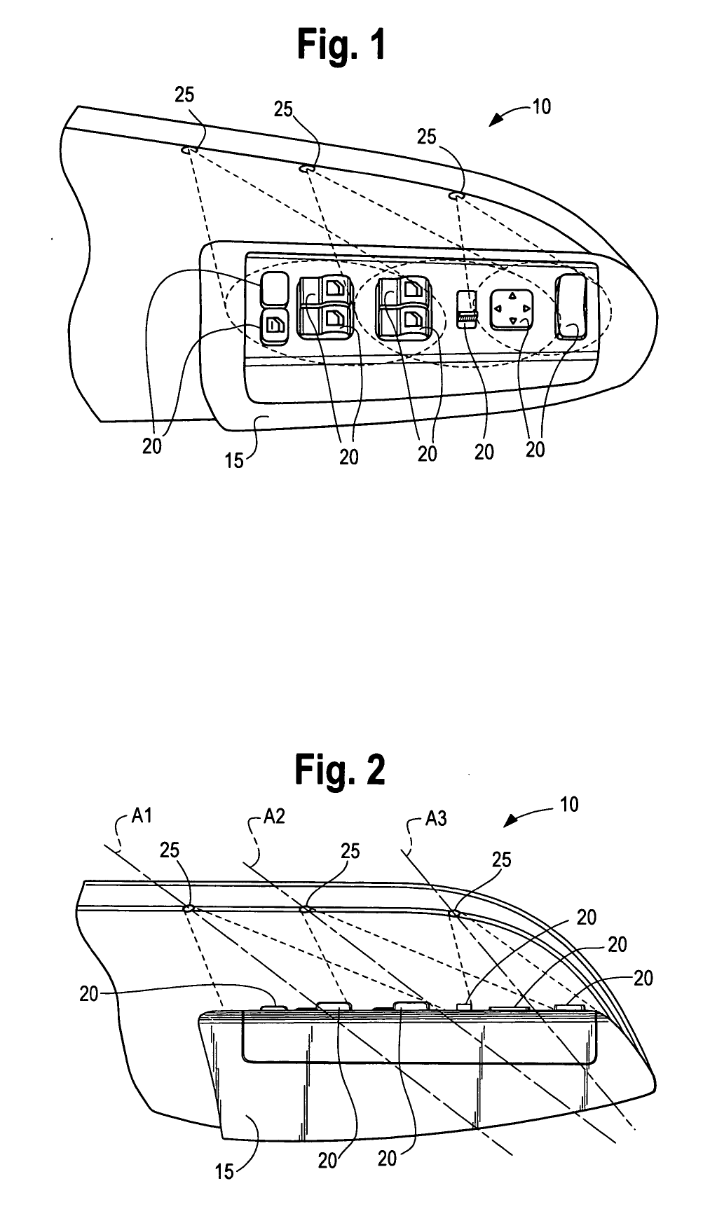

Referring to FIG. 1, an exemplary control illumination apparatus is shown as it would be used in an automobile having an interior door trim panel (shown generally at 10), an arm rest 15 connected to the interior trim panel 10, and a set of controls 20 mounted on the arm rest 15. Although the control illumination apparatus is described herein in relation to an interior door trim with controls set in the arm rest, it will be understood that the present invention could be adapted for use with any interior trim panel that contains controls where illumination of the controls is desired. For example, the controls 20 could be mounted directly to the interior trim 10 without an arm rest. Alternatively, the controls could be mounted in another interior trim of the automobile, such as the ceiling trim. The design of the interior trim of the automobile and placement of controls within such interior trim are well known in the art and are not discussed in detail herein.

Referring to FIGS. 1 and 2, three direct light sources 25 are mounted within the interior trim panel 10, such that they are hidden from view from the passengers in the automobile and do not produce unwanted glare from the windows of the automobile. This can be done by mounting the direct light sources 25 within the interior trim panel 10 such that they are generally aligned with an opening in the interior trim panel (not shown), by positioning the direct light sources 25 within an opening in the interior trim panel (not shown), by integrally forming the direct light sources 25 with the interior trim panel 10, or by mounting the direct light sources 25 in any other well know method appropriate for the desired light source type and desired application. In addition, although the use of three direct light sources 25 is described, it will be understood that any number of direct light sources 25 could be used depending on the number and layout of the controls 20 and the light pattern projected by the direct light sources 25.

Preferably the direct light sources 25 are light emitting diodes (LEDs) due to their small size, their ability to provide directed illumination, and their low heat generation characteristics. Alternatively, the direct light sources 25 could be incandescent lamps or any other light source capable of providing direct illumination, as described in more detail below.

As seen in FIG. 1, each of the direct light sources 25 project illumination on the exterior surfaces of the controls 20 in a predetermined light pattern. The predetermined light pattern is preferably elliptical to illuminate the controls 20 without producing extraneous illumination onto additional parts of the interior trim panel 10, but could be any other pattern desired, such as circular, rectangular, etc. The light patterns of the direct light sources 25 overlap so that if one direct light source is blocked, the overlapping coverage of another direct light source will illuminate at least a portion of the area that was illuminated by the blocked direct light source.

As can best bee seen in FIG. 2, the elliptical light pattern is produced by providing a horizontal offset between the direct light sources 25 and the controls 20 that they illuminate such that the axis of illumination of each direct light source (shown as A1-A3) forms a predetermined angle from vertical. Preferably, this predetermined angle is approximately 45 degrees, but could be any angle between approximately 35 and 50 degrees and would provide the desired result. Alternatively, the predetermined light pattern could be produced by the geometry of the direct light source itself (i.e. by using an elliptical LED to produce an elliptical light pattern) so that the direct light sources 25 would not have to be horizontally offset from the controls 20 that they illuminate.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A control illumination apparatus, comprising:
an interior trim panel including at least one control; and
at least one direct light source connected to the interior trim panel; wherein
the at least one direct light source projects a predetermined light pattern onto an exterior surface of the at least one control.

2. A control illumination apparatus, as recited in claim 1, further comprising an arm rest connected to the interior trim panel wherein the at least one control is disposed within the arm rest.

3. A control illumination apparatus, as recited in claim 1, wherein the at least one direct light source is integral with the interior trim panel.

4. A control illumination apparatus, as recited in claim 1, wherein the at least one direct light source is generally aligned with an opening in the interior trim panel.

5. A control illumination apparatus, as recited in claim 1, wherein the at least one direct light source is positioned within an opening in the interior trim panel.

6. A control illumination apparatus, as recited in claim 1, wherein the at least one direct light source is a light emitting diode.

7. A control illumination apparatus, as recited in claim 1, wherein the at least one direct light source is horizontally offset from the at least one control such that an axis of illumination of the at least one direct light source forms a predetermined angle from vertical.

8. A control illumination apparatus, as recited in claim 7, wherein the predetermined angle is approximately 45 degrees from vertical.

9. A control illumination apparatus, as recited in claim 7, wherein the predetermined angle is between 35 and 55 degrees from vertical.

10. A control illumination apparatus, as recited in claim 1, wherein the predetermined light pattern is elliptical.

11. A control illumination apparatus, as recited in claim 1, further comprising:
a plurality of direct light sources connected to the interior trim panel; and
a plurality of controls; wherein
the plurality of direct light sources project overlapping predetermined light patterns onto exterior surfaces of the plurality of controls.

12. A control illumination apparatus, as recited in claim 11, wherein the predetermined light patterns are elliptical.

13. A method for illuminating a set of controls on an interior trim panel, comprising the steps of:
providing at least one direct light source connected to the interior trim panel; and
projecting a predetermined light pattern from the at least one light source onto an exterior surface of the set of controls.

14. A method for illuminating a set of controls on an interior trim panel, as recited in claim 13, wherein the at least one light source is integral with the interior trim panel.

15. A method for illuminating a set of controls on an interior trim panel, as recited in claim 13, further comprising the step of generally aligning the at least one direct light source with an opening in the interior trim panel.

16. A method for illuminating a set of controls on an interior trim panel, as recited in claim 13, further comprising the step of positioning the at least one direct light source within an opening in the interior trim panel.

17. A method for illuminating a set of controls on an interior trim panel, as recited in claim 13, further comprising the step of aligning an axis of illumination of the direct light source with the controls such that the axis of illumination forms a predetermined angle from vertical.

18. A method for illuminating a set of controls on an interior trim panel, as recited in claim 17, wherein the predetermined angle is between 35 and 55 degrees from vertical.

19. A method for illuminating a set of controls on an interior trim panel, as recited in claim 13, wherein the predetermined light pattern is elliptical.

20. A method for illuminating a set of controls on an interior trim panel, as recited in claim 13, further comprising the steps of:
providing a plurality of direct light sources connected to the interior trim panel; and
aligning the direct light sources such that the direct light sources project overlapping predetermined light patterns onto exterior surfaces of the controls.
